(19) United States
(12) Patent Application Publication
(10) Pub. No.: US 2026/0351848 A1
(43) Pub. Date: Nov. 5, 2026

(54) FUSELAGE ATTENUATION TECHNIQUES

(71) Applicant: Viasat, Inc., Carlsbad, CA (US)

(72) Inventors: Donald L. RUNYON, Duluth, GA (US); Joshua S. ROPER, Atlanta, GA (US); Daryl T. HUNTER, San Marcos, CA (US); M. Brandon STEELE, Decatur, GA (US)

(21) Appl. No.: 19/478,145

(22) PCT Filed: Apr. 25, 2024
(86) PCT No.: PCT/US2024/026328

§ 371 Date: Oct. 23, 2025

Related U.S. Application Data
(60) Provisional application No. 63/498,193, filed on Apr. 25, 2023.

(51) Int. Cl. H01Q 1/52; H01Q 1/28; H01Q 1/42

(52) U.S. Cl. CPC H01Q 1/526; H01Q 1/28; H01Q 1/42

(57) ABSTRACT

Methods, systems, and devices for fuselage attenuation techniques are described. An antenna system may include one or more antennas, and may have a field of view and an operating frequency. The antenna system may be associated with a radome configured for enclosing the antenna system, and a radome attachment structure configured to couple the radome with an exterior surface of a vehicle. One or more signal attenuation features may be mounted (e.g., to the radome attachment structure) below the field of view of the antenna system. The one or more signal attenuation features may be configured to attenuate electromagnetic transmissions of the antenna system at the operating frequency. Such attenuation features may include a conductive structure including a quantity of conductive pillars, a serrated structure including a quantity of conductive serrations, a composite conductor structure, a conductive coating, an arrangement of split conductive rings, or a combination thereof.

### CROSS REFERENCE

The present Application for Patent is a 371 national phase filing of International Patent Application No. PCT/US2024/026328 by Runyon et al., entitled “FUSELAGE ATTENUATION TECHNIQUES,” filed Apr. 25, 2024, which claims the benefit of U.S. Provisional Patent Application No. 63/498,193 by Runyon et al., entitled “FUSELAGE ATTENUATION TECHNIQUES,” filed Apr. 25, 2023, each of which is assigned to the assignee hereof, and each of which is expressly incorporated by reference in its entirety herein.

### FIELD OF TECHNOLOGY

The following relates generally to communication systems, including fuselage attenuation techniques.

### BACKGROUND

Communication systems may include antennas that are configured to communicate information by way of wireless signaling. Wireless signaling may be performed using a wireless spectrum supported by the communication system. An antenna may communicate with one or more other devices of a communication system using the wireless spectrum. However, for mobile applications where an antenna is mounted to a vehicle (e.g., an aircraft), the antenna may transmit signaling while moving near other devices or coverage areas that are not intended for receiving communications from the antenna. In some examples, transmission of wireless signaling using similar frequencies may interfere with communications of another device or communication system.

### SUMMARY

The described techniques relate to improved methods, systems, devices, and apparatuses that support vehicle fuselage attenuation. A vehicle, such as a plane, may include an antenna operable to communicate with other devices (e.g., communication satellites or other overhead devices) of a communication system. For example, the antenna may support transmitting and receiving information via wireless signaling communicated using a wireless spectrum (e.g., in an operating frequency band, which may correspond to a range of frequencies). In some cases, similar (e.g., at least partially overlapping) operating frequencies of a wireless spectrum may be used by other devices (e.g., terrestrial devices, devices at a lower altitude) or other communication systems for communicating wireless signaling, such that the antenna may share at least a portion of the wireless spectrum with the other devices or communication systems. In mobile applications, for example, the antenna may be associated with (e.g., mounted to) a vehicle, which may move near coverage areas of other communication systems. For example, the antenna may be mounted to an aircraft and the aircraft may travel through or above the coverage areas of the other communication systems. However, because an antenna and other communication devices may share a similar wireless spectrum, transmissions from the antenna may interfere with the other communication devices when the antenna moves near the coverage areas of the other communication systems. For example, when the antenna is above a coverage area of another communication system, wireless signaling transmitted from the antenna may interfere with wireless signaling communicated by the other communication system.

In some cases, a physical positioning of the antenna relative to the vehicle may be associated with generating interference with the other communication systems. For example, an antenna may be mounted along a top surface of an aircraft, and may be configured to communicate wireless signaling in a region (e.g., a field of view) defined by angles relative to the aircraft. The antenna may be configured to communicate via electromagnetic transmissions within the region, which may include signaling in accordance with directions (e.g., boresight directions) of peak gain that are generally above or beside the airplane. The region the antenna is configured to communicate wireless signaling is “line-of-sight (LOS)” satellite communications when the two stations (e.g., antenna and satellite) have a direct signal path between stations. However, in some cases, electromagnetic transmissions from the antenna may propagate outside the region (e.g., below the region), such that the electromagnetic transmissions outside the region (e.g., outside an angle relative to the aircraft, below an angle relative to the aircraft) may cause interference for the other communications systems communicating via the similar wireless spectrum (e.g., systems or devices at a lower altitude or elevation). In some such cases, a fuselage of the aircraft may at least partially attenuate the electromagnetic transmissions along one or more directions below the fuselage. However, a degree of fuselage attenuation may vary according to an antenna operating frequency (e.g., one or more frequencies of an operating frequency band), a size and shape of the fuselage, and other features of the aircraft such as the wing and tail, and a portion of the electromagnetic transmissions may still cause interference for the other communication systems.

In accordance with examples as described herein, an antenna signal attenuation apparatus may be implemented on a vehicle (e.g., on a fuselage) to mitigate signal propagation that may interfere with other devices or other communication systems. For example, an antenna signal attenuation apparatus may be implemented on a vehicle (e.g., on a fuselage) to increase signal attenuation in a region below LOS communications to a target satellite or other target device. The antenna signal attenuation apparatus may include a mounting structure, such as a radome attachment structure or a fairing, configured for coupling with a surface of a vehicle via an interface of the mounting structure. In some implementations, the mounting structure may be configured for mounting above the vehicle (e.g., along a top surface of the vehicle). In some implementations, an antenna system may be mounted to the vehicle within an opening of the mounting structure, which may include mounting the antenna system directly to the vehicle. In some other implementations, an antenna system may be mounted to the mounting structure via another interface of the mounting structure. The antenna signal attenuation apparatus may include one or more signal attenuation features mounted to (e.g., coupled with, affixed to, fastened to, different than) the mounting structure and configured to attenuate electromagnetic transmissions of an antenna system (e.g., in an operating frequency band of the antenna system, outside a field of view of the antenna system). For example, the attenuation features, such as metamaterials and other attenuation features, may impede, absorb, redirect (e.g., reflect, absorb and reemit), or modify (e.g., disrupt a coherence, depolarize) electromagnetic transmissions propagating outside a field of view of the antenna system relative to the vehicle, thereby reducing interference caused by the electromagnetic transmissions outside the field of view. In some examples, the attenuation features may be configured to limit electromagnetic transmissions propagating below an angle relative to the vehicle (e.g., a shadow boundary below which direct line-of-sight radiation does not occur without obstruction), which may prevent the electromagnetic transmissions from interfering with wireless signaling communicated by other devices (e.g., ground-based devices) that may be using the similar wireless spectrum.

Described examples of attenuation features may include conductive structures, composite conductor structures, serrated structures, resonant conductor structures, split conductive rings, conductive or partially-conductive (e.g., resistive type) coatings applied to one or more surfaces of the mounting structure, or a combination thereof. For example, conductive structures implemented for signal attenuation may include conductive pillars (e.g., prismatic pillars, pyramidal pillars), which may be arranged in a pattern on a top surface of the mounting structure. Composite conductor structures implemented for signal attenuation may include a pattern of conductive structures formed with one or more dielectric layers (e.g., in accordance with printed circuit board (PCB) techniques or other additive or subtractive techniques), which may be arranged on a top surface of the mounting structure. Serrated structures implemented for signal attenuation may include conductive serrations arranged at one or more angles (e.g., relative to the top surface of the radome attachment structure), which may be mounted to a top surface of the mounting structure. Split conductive rings implemented for signal attenuation may be arranged on a side surface of the mounting structure and may be configured to disrupt signal coherence, or depolarize the electromagnetic transmissions by rotating individual conductive rings relative to one another in groups of rings, or both. Conductive or partially conductive coatings implemented for signal attenuation may be applied to the side surface of a composite material of the mounting structure. Implementing attenuation features on a mounting structure of a vehicle, such as a radome attachment structure, may attenuate electromagnetic transmissions of an antenna system, thereby mitigating interference to other devices or communication systems.

Further scope of the applicability of the described methods and systems will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

FIG. 1 shows an example of a satellite communication system that supports fuselage attenuation techniques in accordance with examples described herein.

FIGS. 2A, 2B, and 2C show aspects of systems that support fuselage attenuation techniques in accordance with examples as described herein.

FIGS. 3A, 3B, and 3C show an example of a system that supports fuselage attenuation techniques in accordance with examples as described herein.

FIGS. 4A and 4B show examples of composite conductors structure that support fuselage attenuation techniques in accordance with examples as described herein.

FIGS. 5 through 7 show examples of systems that support fuselage attenuation techniques in accordance with examples as described herein.

### DETAILED DESCRIPTION

The described techniques relate to improved methods, systems, devices, and apparatuses that support vehicle fuselage attenuation. A vehicle, such as a plane, may include an antenna operable to communicate with other devices (e.g., communication satellites or other overhead devices) of a communication system. For example, the antenna may support transmitting and receiving information via wireless signaling communicated using a wireless spectrum (e.g., in an operating frequency band, which may correspond to a range of frequencies). In some cases, similar (e.g., at least partially overlapping) operating frequencies of a wireless spectrum may be used by other devices (e.g., terrestrial devices, devices at a lower altitude) or other communication systems for communicating wireless signaling, such that the antenna may share at least a portion of the wireless spectrum with the other devices or communication systems. In mobile applications, for example, the antenna may be associated with (e.g., mounted to) a vehicle, which may move near coverage areas of other communication systems. For example, the antenna may be mounted to an aircraft and the aircraft may travel through or above the coverage areas of the other communication systems. However, because an antenna and other communication devices may share a similar wireless spectrum, transmissions from the antenna may interfere with the other communication devices when the antenna moves near the coverage areas of the other communication systems. For example, when the antenna is above a coverage area of another communication system, wireless signaling transmitted from the antenna may interfere with wireless signaling communicated by the other communication system.

In some cases, a physical positioning of the antenna relative to the vehicle may be associated with generating interference with the other communication systems. For example, an antenna may be mounted along a top surface of an aircraft, and may be configured to communicate wireless signaling in a region (e.g., a field of view) defined by angles relative to the aircraft. The antenna may be configured to communicate via electromagnetic transmissions within the region, which may include signaling in accordance with directions (e.g., boresight directions) of peak gain that are generally above or beside the airplane. The region the antenna is configured to communicate wireless signaling is “line-of-sight (LOS)” satellite communications when the two stations (e.g., antenna and satellite) have a direct signal path between stations. However, in some cases, electromagnetic transmissions from the antenna may propagate outside the region (e.g., below the region), such that the electromagnetic transmissions outside the region (e.g., outside an angle relative to the aircraft, below an angle relative to the aircraft) may cause interference for the other communications systems communicating via the similar wireless spectrum (e.g., systems or devices at a lower altitude or elevation). In some such cases, a fuselage of the aircraft may at least partially attenuate the electromagnetic transmissions along one or more directions below the fuselage. However, a degree of fuselage attenuation may vary according to an antenna operating frequency (e.g., one or more frequencies of an operating frequency band), a size and shape of the fuselage, and other features of the aircraft such as the wing and tail, and a portion of the electromagnetic transmissions may still cause interference for the other communication systems.

In accordance with examples as described herein, an antenna signal attenuation apparatus may be implemented on a vehicle (e.g., on a fuselage) to mitigate signal propagation that may interfere with other devices or other communication systems. For example, an antenna signal attenuation apparatus may be implemented on a vehicle (e.g., on a fuselage) to increase signal attenuation in a region below LOS communications to a target satellite or other target device. The antenna signal attenuation apparatus may include a mounting structure, such as a radome attachment structure or a fairing, configured for coupling with a surface of a vehicle via an interface of the mounting structure. In some implementations, the mounting structure may be configured for mounting above the vehicle (e.g., along a top surface of the vehicle). In some implementations, an antenna system may be mounted to the vehicle within an opening of the mounting structure, which may include mounting the antenna system directly to the vehicle. In some other implementations, an antenna system may be mounted to the mounting structure via another interface of the mounting structure. The antenna signal attenuation apparatus may include one or more signal attenuation features mounted to (e.g., coupled with, affixed to, fastened to, different than) the mounting structure and configured to attenuate electromagnetic transmissions of an antenna system (e.g., in an operating frequency band of the antenna system, outside a field of view of the antenna system). For example, the attenuation features, such as metamaterials and other attenuation features, may impede, absorb, redirect (e.g., reflect, absorb and reemit), or modify (e.g., disrupt a coherence, depolarize) electromagnetic transmissions propagating outside a field of view of the antenna system relative to the vehicle, thereby reducing interference caused by the electromagnetic transmissions outside the field of view. In some examples, the attenuation features may be configured to limit electromagnetic transmissions propagating below an angle relative to the vehicle (e.g., a shadow boundary below which direct line-of-sight radiation does not occur without obstruction), which may prevent the electromagnetic transmissions from interfering with wireless signaling communicated by other devices (e.g., ground-based devices) that may be using the similar wireless spectrum.

Described examples of attenuation features may include conductive structures, composite conductor structures, serrated structures, resonant conductor structures, split conductive rings, conductive or partially-conductive (e.g., resistive type) coatings applied to one or more surfaces of the mounting structure, or a combination thereof. For example, conductive structures implemented for signal attenuation may include conductive pillars (e.g., prismatic pillars, pyramidal pillars), which may be arranged in a pattern on a top surface of the mounting structure. Composite conductor structures implemented for signal attenuation may include a pattern of conductive structures formed with one or more dielectric layers (e.g., in accordance with printed circuit board (PCB) techniques or other additive or subtractive techniques), which may be arranged on a top surface of the mounting structure. Serrated structures implemented for signal attenuation may include conductive serrations arranged at one or more angles (e.g., relative to the top surface of the radome attachment structure), which may be mounted to a top surface of the mounting structure. Split conductive rings implemented for signal attenuation may be arranged on a side surface of the mounting structure and may be configured to disrupt signal coherence, or depolarize the electromagnetic transmissions by rotating individual conductive rings relative to one another in groups of rings, or both. Conductive or partially conductive coatings implemented for signal attenuation may be applied to the side surface of a composite material of the mounting structure. Implementing attenuation features on a mounting structure of a vehicle, such as a radome attachment structure, may attenuate electromagnetic transmissions of an antenna system, thereby mitigating interference to other devices or communication systems.

Aspects of the examples as described herein are initially described in the context of satellite communication systems. Aspects of the examples as described herein are further illustrated by and described with reference to systems and attenuation features that relate to fuselage attenuation techniques.

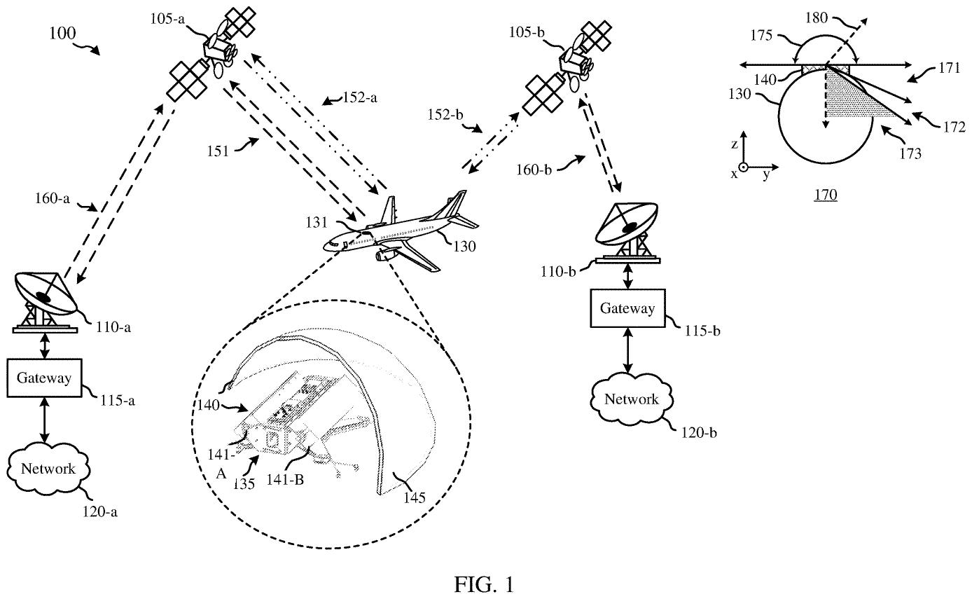

FIG. 1 shows a diagram of a communication system 100 that may implement one or more fuselage attenuation techniques in accordance with examples as described herein. A communication system 100 may include a first satellite 105-a, a first gateway 115-a, a first gateway antenna system 110-a, and an vehicle 130 (e.g., an aircraft). The first gateway 115-a may communicate with at least a first network 120-a. A communication system 100 can provide for one-way or two-way communications between the vehicle 130 and the first network 120-a through at least the first satellite 105-a and the first gateway 115-a. In some examples, a communication system 100 may include a second satellite 105-b, a second gateway 115-b, and a second gateway antenna system 110-b. The second gateway 115-b may communicate with at least a second network 120-b. A communication system 100 can provide for one-way or two-way communications between the vehicle 130 and the second network 120-b through at least the second satellite 105-b and the second gateway 115-b. In some examples, the network 120-a and the network 120-b may be coupled, or may be a same network, among other implementations. Although two satellites 105 are illustrated, the communication system 100 may be implemented with any quantity of one or more satellites 105 that support communications with any quantity of one or more networks 120.

The satellites 105 may be any suitable type of communication satellite. In some examples, one or more satellites 105 may be in a geostationary orbit. In other examples, any appropriate orbit (e.g., a non-geostationary orbit (NGSO), a low earth orbit (LEO), a medium earth orbit (MEO)) may be used for a satellite 105. A satellite 105 may be a multi-beam satellite (e.g., using one or more multi-beam reflector antennas, multi-beam fixed arrays, or phased arrays) configured to provide service for multiple service beam coverage areas in a geographical service area. A first satellite 105-a and a second satellite 105-b may support a communication service in non-overlapping coverage areas, partially-overlapping coverage areas, or fully-overlapping coverage areas.

A first gateway antenna system 110-a may be one-way or two-way capable and designed with adequate transmit power and receive sensitivity to communicate with a first satellite 105-a. The first satellite 105-a may communicate with the first gateway antenna system 110-a by sending or receiving signals 160-a (e.g., beams, beam signals, beamformed beams of one or more phased arrays). The first gateway 115-a may send and receive signals to and from the first satellite 105-a using the first gateway antenna system 110-a. The first gateway 115-a may be connected with the first network 120-a. The first network 120-a may include a local area network (LAN), metropolitan area network (MAN), wide area network (WAN), or any other suitable public or private network and may be connected to other communications networks such as the Internet, telephony networks (e.g., Public Switched Telephone Network (PSTN)), and the like.

Examples of a communication system 100 may include a second satellite 105-b, along with components of the communication system 100 that are unique to the second satellite 105-b or shared with other satellites 105 (e.g., first satellite 105-a). For example, a second gateway antenna system 110-b may be one-way or two-way capable and designed with adequate transmit power and receive sensitivity to communicate reliably with a second satellite 105-b. The second satellite 105-b may communicate with the second gateway antenna system 110-b by sending and receiving signals 160-b. The second gateway 115-b may send and receive signals to and from the second satellite 105-b using the second gateway antenna system 110-b. The second gateway 115-b may be connected with the second network 120-b. The second network 120-b may include a local area network (LAN), metropolitan area network (MAN), wide area network (WAN), or any other suitable public or private network and may be connected to other communications networks such as the Internet, telephony networks (e.g., Public Switched Telephone Network (PSTN), etc.), and the like.

In various examples, the first network 120-a and the second network 120-b may be different networks, coupled networks, or the same network 120. In various examples, the first gateway 115-a and the second gateway 115-b may be different gateways, or the same gateway 115. In various examples, the first gateway antenna system 110-a and the second gateway antenna system 110-b may be different gateway antenna systems, or the same gateway antenna system 110.

A vehicle 130 can employ a communication system that includes an antenna system 140. An antenna system 140 may include any quantity of one or more antennas 141. For example, as illustrated, the antenna system 140 may include a first antenna 141-a and a second antenna 141-b. In various examples, an antenna 141 may include a reflector-type antenna (e.g., with a reflector and at least one antenna element), an array antenna (e.g., an antenna with an array of multiple antenna elements), a phased array antenna (e.g., an antenna with an array of multiple antenna elements operable to form a beam along a beamformed beam direction), or another type of antenna. In some examples, an antenna 141 may include a dual polarized planar horn antenna array (e.g., including a phased array of antenna elements). In some examples, a first antenna 141-a and a second antenna 141-b may be a same type of antenna, or different types of antennas. An antenna system 140 can be mounted on an exterior surface 131 of a fuselage of a vehicle 130, and may be located under a radome 145 (e.g., associated with a volume for arrangement of the antenna system 140, for at least partially enclosing the antenna system 140).

In some implementations, an antenna system 140 may include a steering system 135 (e.g., a beam steering system) configured to point (e.g., steer, align, direct) a boresight 180 of the antenna system 140 (e.g., a direction of peak gain, a direction of highest transmission strength, a direction of highest reception sensitivity). In some examples, a steering system 135 may include a mechanical steering system (e.g., a positioning mechanism) that is configured to physically point one or more antennas 141 (e.g., an antenna aperture, a respective boresight 180 of one or more antennas 141) toward a target, such as in alignment toward a satellite 105 during operation (e.g., in accordance with an active mechanical tracking). In some examples, a mechanical steering system may include a system to physically control an orientation of one or more antennas 141 of an antenna system 140 about one or more axes (e.g., positioning axes, mechanical positioning axes), such as within a field of view of the antenna system 140. For example, a mechanical steering system may include components operable to control an azimuth orientation of an antenna 141 and an elevation orientation of the antenna 141, among other orientations (e.g., relative to a coordinate system of the vehicle 130). Additionally, or alternatively, a steering system 135 may include an electronic steering system (e.g., a beamforming system) that is configured to electronically steer one or more beams (e.g., one or more transmit beams, one or more receive beams) of one or more antennas 141 toward a target. For example, an electronic steering system may include a system to electronically steer a boresight 180 of an antenna system 140 based on adjusting feed element signals (e.g., by phase offset, by time offset, by amplitude offset) of an array of antenna elements (e.g., in an absence of a mechanical steering system, in addition to a mechanical steering system).

In some examples, an antenna 141 may operate in the International Telecommunications Union (ITU) Ku, K, or Ka-bands, for example, from approximately 17 to 31 Giga-Hertz (GHz) (e.g., an operating frequency band).

Additionally, or alternatively, an antenna 141 may operate in other frequency bands (e.g., other operating frequency bands) such as C-band, X-band, S-band, L-band, and the like. In various examples, a first antenna 141-a and a second antenna 141-b may be configured to operate in different frequency bands (e.g., such that an operating frequency of an antenna system 140 may include the operating frequencies of multiple antennas 141), or in the same frequency band. For example, a first antenna 141-a can be configured to operate at Ku-band (e.g., receiving signals between 10.95 and 12.75 GHz, transmitting signals between 14.0 to 14.5 GHz), and a second antenna 141-b can be configured to operate at Ka-band (e.g., receiving signals between 17.7 and 21.2 GHZ, transmitting signals between 27.5 to 31.0 GHz). In some examples, a first antenna 141-aand a second antenna 141-b may be configured with different dimensions, or other characteristics that may be leveraged in different communications circumstances, such as a first antenna 141-a being relatively smaller and having a relatively lower transmission or reception directionality (e.g., relatively lower beam gain, relatively broader beam focus), and a second antenna 141-b being relatively larger and having a relatively greater transmission or reception directionality (e.g., relatively higher beam gain, relatively tighter beam focus).

In some examples, a first antenna 141-a may be associated with a first satellite 105-a, and a second antenna 141-b can be associated with a second satellite 105-b. In operation, the vehicle 130 can have a location that is within a coverage area of the first satellite 105-a, within a coverage area of the second satellite 105-b, or both and, in some examples, communications with either the first antenna 141-a or the second antenna 141-b can be selected based at least in part on the position of a vehicle 130. For instance, in a first mode of operation, while a vehicle 130 is located within a coverage area of a first satellite 105-a, the vehicle 130 can use a first antenna 141-a of the antenna system 140 to communicate with the first satellite 105-a via signals 151 (e.g., beams, beam signals, beamformed beams). In the first mode of operation, a second antenna 141-b can be in an inactive state or idled state without maintaining a communications link with a satellite 105. In some examples, during at least a portion of the first mode of operation, a second antenna 141-b may be physically idled, such that an actuation of a shared drive element (e.g., a drive element that is common to the first antenna 141-a and the second antenna 141-b) does not actuate the second antenna 141-b.

In a second mode of operation, while the vehicle 130 is located within a coverage area of a second satellite 105-b, the vehicle 130 can use a second antenna 141-b of the antenna system 140 to communicate with the second satellite 105-b via signals 152-b (e.g., beams, beam signals, beamformed beams). The second mode can be selected, for instance, in response to the vehicle 130 entering a coverage area of the second satellite 105-b, leaving a coverage area of the first satellite 105-a, or both. In the second mode of operation, the first antenna 141-a can be in an inactive state or idled state without maintaining a communications link with a satellite 105. In some examples, during at least a portion of the second mode of operation, the first antenna 141-a may be physically idled, such that an actuation of a shared drive element does not actuate the first antenna 141-a. In examples where the vehicle 130 is located within an overlapping coverage area of both a first satellite 105-a and a second satellite 105-b, the second mode can be selected based on other factors, such as network availability, communication capacity, communication costs, signal strength, signal quality, or other parameters or combination of parameters.

In some other examples, a first antenna 141-a and a second antenna 141-b can both be associated with (e.g., support communications with) a first satellite 105-a. In the first mode of operation the vehicle 130 can use the first antenna 141-a to communicate with the first satellite 105-a via signals 151, and, in an alternate example of the second mode of operation, the vehicle 130 can use the second antenna 141-b to communicate with the first satellite 105-a via signals 152-a. The alternate example of the second mode can be selected, for instance, in the event of an error condition, a fault condition, or a degradation of the first antenna 141-a, where the second antenna 141-b can provide backup communications. Additionally, or alternatively, the alternate example of the second mode can be selected to change from a first operating frequency (e.g., a first operating frequency band) or communications protocol associated with the first antenna 141-a to a second operating frequency (e.g., a second operating frequency band) or communications protocol associated with the second antenna 141-b. Additionally, or alternatively, to support communications under various circumstances, the antenna system 140 may be configured to select either a first antenna 141-a or a second antenna 141-b based on other criteria, such as a size or positioning constraint of one or both of the first antenna 141-a or the second antenna 141-b, or an antenna or beam characteristic of one or both of the first antenna 141-a or the second antenna 141-b, or a combination thereof.

In some examples, a communication system of a vehicle 130 can provide communication services for communication devices within the vehicle 130 via a modem (not shown). Communication devices may utilize the modem to connect to and access at least one of the first network 120-a or the second network 120-b via the antenna system 140. For example, mobile devices may communicate with at least one of the first network 120-a or the second network 120-b via network connections to modem, which may be wired or wireless. A wireless connection may be, for example, of a wireless local area network (WLAN) technology such as IEEE 802.11 (Wi-Fi), or other wireless communication technology.

In some cases, electromagnetic transmissions from one or more antennas 141 of an antenna system 140 may cause interference to other devices, which may be operating in a same communication system as or different communication system than the antenna system 140. For example, an antenna system 140, such as an aeronautical earth station in motion (e.g., ESIM), may be designed to conform with power flux density (PFD) limits, such as on the Earth's surface. An objective of such limits may be to ensure that antenna systems 140, such as ESIMs, do not interfere with terrestrial devices or communication systems that may be using the same spectrum.

As illustrated in the view 170 (e.g., a simplified cross-sectional view of an antenna system 140 mounted to a vehicle 130), an antenna system 140 may be mounted atop a vehicle 130 (e.g., along a surface or edge of attachment of a surface 131, a surface atop a vehicle 130 generally along a positive z-direction), such as atop a fuselage of an aircraft. The view 170 illustrates different regions of signaling (e.g., regions electromagnetic transmissions of the antenna system 140) relative to the vehicle 130 and the antenna system 140 in accordance with a coordinate system (e.g., a coordinate system of the vehicle 130, where an x-direction may be aligned along a direction of travel of the vehicle 130, a y-direction may be aligned along a left-right direction of the vehicle, and a z-direction may be aligned along an upward-downward direction of the vehicle). For example, the antenna system 140 may be associated with a field of view 175 (e.g., supported directions of communication signaling), where the antenna system 140 may have a boresight 180 that is configurable (e.g., mechanically-configurable, electronically-configurable, or both, steerable) within the field of view 175. In the illustrated example of FIG. 1, the field of view 175 is associated with horizontal directions (e.g., directions in an xy-plane) and directions having at least a component along the positive z-direction (e.g., directions relatively upward from the xy-plane). However, in some other examples, a field of view 175 may be relatively broader (e.g., including at least some boresight directions that are relatively downward from an xy-plane), or relatively narrower (e.g., omitting directions in an xy-plane, omitting at least some relatively upward directions that are less than a threshold angle from an xy-plane).

Aspects of electromagnetic transmissions and signal attenuation may be described relative to a field of view 175 which, although illustrated in a yz-plane, may be associated with azimuth angles (e.g., measured in an xy-plane) and elevation angles (e.g., measured relative to the xy-plane), such that a field of view 175 may refer to a three-dimensional region relative to a vehicle 130. For example, a region 171 may refer to a “visible region,” associated with a line-of-sight view of electromagnetic transmissions from the antenna system 140 (e.g., directions of transmission that are not coincident with a body of the vehicle 130). In some examples, the region 171 (e.g., in a yz-plane) may correspond to 23 degrees downward or less off-axis elevation angle relative to an antenna 141 pointing along the y-direction (e.g., to a port or starboard side of the vehicle). In some examples, a body of the vehicle 130 (e.g., the fuselage of the aircraft) may block and attenuate at least some electromagnetic radiation outside of (e.g., below) the region 171. For example, a region 173 may refer to a “deep shadow region,” and a region 172 may refer to a “transition region” between the region 171 and the region 173. Some relatively weaker surface currents may be present (e.g., in a fuselage of the vehicle 130) below the region 171 (e.g., in the region 173, in the region 172), and may re-radiate (e.g., as “creeping waves”). In a region 173, attenuation effects may be dominated by the body of the vehicle 130 (e.g., fuselage attenuation, creeping waves). In a region 172, a region 171, or both, attenuation effects may be dominated by one or more attenuation features, which may be coupled with a fairing or other mounting structure (e.g., a mounting structure). Although aspects of a region 171, a region 172, and a region 173 are illustrated and described with reference to a yz-plane, such regions may have different sizes in locations along an xz-plane (e.g., due to a fuselage having a relatively elongated cross-section along the x-direction), among other orientations, such that regions 171, 172, and regions 173 may have irregular shapes (e.g., volumes) around a vehicle 130 and antenna system 140.

In accordance with examples as described herein, an antenna signal attenuation apparatus may be implemented on a vehicle 130 (e.g., on a body of the vehicle 130, on a fuselage of the vehicle 130) to mitigate signal propagation that may interfere with other devices or other communication systems (e.g., terrestrial communications). In some implementations, an antenna signal attenuation apparatus may include a mounting structure, such as a radome attachment structure (e.g., for mounting a radome 145 to the vehicle 130), a fairing (e.g., separate from a radome attachment structure) or other mounting structure configured for coupling with a surface 131 of a vehicle 130 via an interface of the mounting structure. In some examples, the mounting structure may be configured for mounting above the vehicle 130 (e.g., along a top surface of the vehicle 130, towards a positive z-direction). In some implementations, an antenna system 140 may be mounted to the vehicle 130 within (e.g., through) an opening of the mounting structure, which may include mounting the antenna system 140 directly to the vehicle 130. In some other examples, an antenna system 140 may be mounted to the mounting structure via another interface of the mounting structure.

An antenna signal attenuation apparatus may include one or more attenuation features that, in some examples, may be mounted to (e.g., coupled with, affixed to, fastened to) a mounting structure and configured to attenuate electromagnetic transmissions of an antenna system 140 (e.g., in an operating frequency band of the antenna system 140, outside a field of view 175, in a region 173, in a region 173 and a region 172, in regions 171, 172, and 173), or otherwise configured to mount to a vehicle 130 to support the described techniques for signal attenuation. For example, the attenuation features may impede, absorb, redirect (e.g., reflect, absorb and reemit), or modify (e.g., disrupt a coherence, depolarize) electromagnetic transmissions propagating outside a field of view 175 of the antenna system 140 relative to the vehicle 130, thereby reducing interference caused by the electromagnetic transmissions outside the field of view 175. In some examples, the attenuation features may be configured to limit electromagnetic transmissions propagating below an angle relative to the vehicle 130 (e.g., undesired off-axis emissions, emissions below an angle of a field of view 175), which may prevent the electromagnetic transmissions from interfering with wireless signaling communicated by other devices (e.g., ground-based devices) that may be using a similar wireless spectrum. In some examples, signal attenuation features may be configured to attenuate electromagnetic transmissions from propagating below a mounting structure, such as below a radome attachment structure, among other examples.

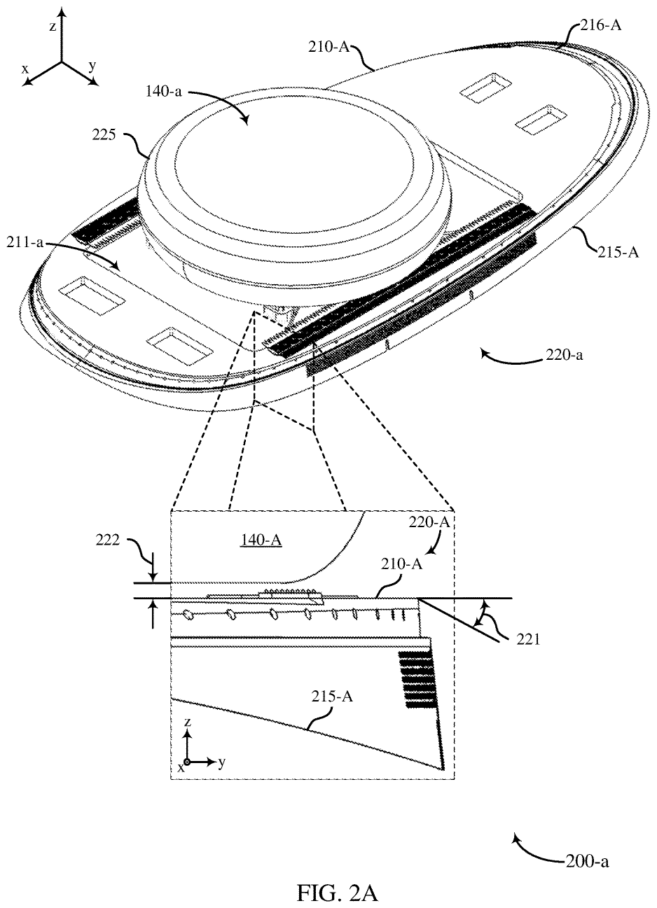

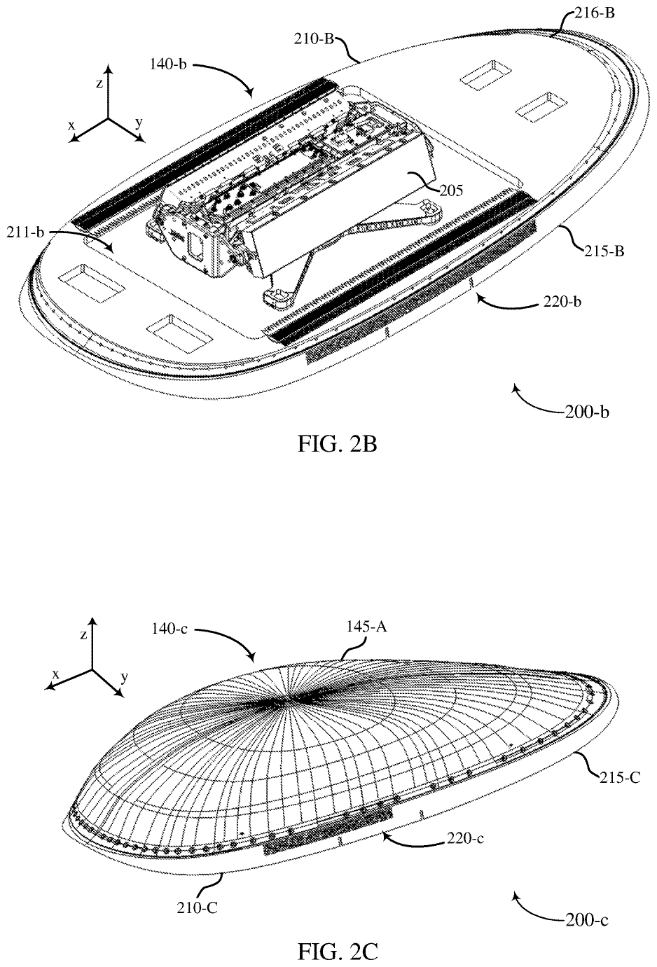

FIGS. 2A through 2C show aspects of systems 200 that support fuselage attenuation techniques in accordance with examples as described herein. A system 200 may be implemented in a communication system 100. For example, a system 200 (e.g., attenuation features 220) may be mounted to a vehicle 130, such as an aircraft. Aspects of systems 200 (e.g., a system 200-a, a system 200-b, a system 200-c) may be described with reference to the illustrated coordinate systems, which may correspond to coordinate systems of a vehicle 130 (e.g., an aircraft). FIGS. 2A through 2C illustrate systems 200 from various trimetric views, with FIG. 2A illustrating a system 200-a with an additional detailed front view in a yz-plane. A system 200 may include an antenna system 140 and one or more attenuation features 220 configured to attenuate electromagnetic transmissions of the antenna system 140 (e.g., sidelobe transmissions, transmissions along one or more directions different than a target receiving device, emissions along directions different than a field of view 175, spurious emissions), which may mitigate interference to other devices or communication systems (e.g., below a vehicle 130 that includes a system 200).

An antenna system 140 may include one or more antennas 141 (e.g., one or more reflector-type antennas, one or more array antennas, one or more phased array antennas, or a combination thereof, among other types or combinations of antennas) that are configured to communicate wireless signaling. For example, an antenna system 140-a of a system 200-a may include an antenna 141 (e.g., not shown, which may be a single antenna 141) having one or more antenna elements (e.g., an array of antenna elements, a phased array) that may be fixed in a coordinate system of a vehicle 130 that includes the system 200-a (e.g., without a steering system 135, without a mechanical steering system), such as antenna elements that may be statically aligned along the z-direction (e.g., for transmission or reception of signals at least partially along the z-direction, which may include electronic beamforming of a steering system 135 for signaling along a boresight 180 with vector components in an x-direction, a y-direction, or a combination thereof). In the example of system 200-a, such an antenna 141 may be arranged in (e.g., located inside, enclosed within, arranged in a volume of) a cover 225. In some other examples, a cover 225 may be omitted from an antenna system 140-a.

In another example, an antenna system 140-b of a system 200-b may include one or more antennas (e.g., two antennas 141), each associated with one or more antenna elements of an aperture 205, which may be physically oriented by a steering system 135 (e.g., a mechanical steering system, a positioning mechanism). For example, the steering system 135 may be operable to adjust an elevation angle and an azimuth angle of each of one or more apertures 205 (e.g., independently, simultaneously). In some examples, the steering system 135 may be configured to rotate each of the apertures 205 about an axis parallel to an xy-plane to adjust an elevation orientation (e.g., an elevation angle), and to rotate the apertures 205 about an axis parallel to the z-direction to adjust an azimuth orientation (e.g., an azimuth angle). In some examples, an aperture 205 may be associated with a plurality of antenna elements, and a steering system 135 may also include an electronic steering system (e.g., a beamforming system). Such techniques may be implemented in an antenna system 140-b with any quantity of one or more antennas 141 (e.g., any quantity of one or more apertures 205), and the antennas 141 (e.g., the apertures 205) may be associated with a swept volume corresponding to an overall volume occupied by the antennas 141 or apertures 205 at different orientations that may be driven by a mechanical portion of the steering system 135. Thus, in these and other examples, an antenna system 140 may include a steering system 135 that is configured to steer a boresight 180 of an antenna system 140 within a field of view 175. In some examples, an antenna system 140-b may include a cover 225 over antennas 141 (e.g., over apertures 205, enclosing a swept volume of antennas 141, not shown).

In these and other examples, a system 200 may include a radome 145 associated with a volume for arrangement of (e.g., to at least partially enclose) an antenna system 140. For example, as illustrated in FIG. 2C, a system 200-c may include a radome 145-a that is associated with a volume for arrangement of an antenna system 140-c (not shown), which may include aspects of an antenna system 140-a, an antenna system 140-b, or another type of antenna system 140. A radome 145-a may be associated with protecting the antenna system 140-c (e.g., from debris, from wind), or facilitating airflow around the antenna system 140-c (e.g., to reduce fuel consumption of the vehicle 130), or both. Some antenna systems 140 may include one or more reflectors (e.g., of a reflector antenna 141, within a radome 145, under a radome 145), such as a low, medium or high-profile reflector antenna configuration, or a combination thereof.

The antenna system 140-a, 140-b, and 140-c among other configurations of antenna systems 140, may be operable to support communications with other devices (e.g., satellites 105) of a communication system by communicating (e.g., transmitting, receiving) electromagnetic signals. Electromagnetic transmissions may include electromagnetic waves in accordance with one or more frequencies of an operating frequency band of the respective antenna system 140 (e.g., of one or more antennas 141). In some cases, adjusting the orientation of apertures 205 or other steering (e.g., electronic steering, beamforming, using a steering system 135) may alter a direction of transmission from the apertures 205. For example, an antenna 141 may be configured for transmitting electromagnetic waves along a boresight 180 (e.g., a boresight direction, a direction of peak gain, a direction of highest transmission strength) from an aperture 205 (e.g., in accordance with one or more frequencies of an operating frequency band) that propagate along one or more directions (e.g., directions associated with a field of view 175, beam directions, beamformed beam directions) relative to the orientation of the aperture 205. Thus, in accordance with these and other examples, an antenna system 140 of a system 200 may have a field of view 175 for communicating electromagnetic signals, which may be along various directions from the antenna system 140 that are different than directions toward a vehicle 130 (e.g., toward a fuselage) on which the antenna system 140 is mounted.

A system 200 that includes an antenna system 140 may be mounted to a fuselage of a vehicle 130 (e.g., an aircraft), such that one or more antennas 141 of the antenna system 140 may be configured to transmit electromagnetic transmissions in a region (e.g., a field of view 175) defined relative to the vehicle 130. For example, an antenna system 140-a or an antenna system 140-b may be mounted to a top surface of a fuselage of an aircraft. In some such cases, a body of the vehicle 130 (e.g., a fuselage) may at least partially attenuate electromagnetic transmissions propagating below an angle relative to the antenna system 140. For example, a fuselage may at least partially block electromagnetic transmissions below an angle (e.g., in a region 173, in a deep shadow region). However, a fuselage may not sufficiently attenuate electromagnetic transmissions above the angle (e.g., in a region 171, in a visible line-of-sight region), or below an angle tangential to an exterior surface of the fuselage (e.g., in a region 172, in a transition region). In some implementations, electromagnetic transmissions below an angle relative to the antenna system 140-a may include unwanted sidelobes produced by one or more arrays of antenna elements (e.g., sidelobes associated with beamforming of a transmit beam of a phased array), among other transmissions, which may adversely affect communications of other devices or communication systems (e.g., of a terrestrial communication system).

A system 200 may also include a radome attachment structure 210 (e.g., a mounting structure, a fairing), which may be configured for mounting to a body of a vehicle (e.g., an exterior surface of the vehicle 130, a fuselage of an aircraft). A radome attachment structure may be formed from various materials, such as plastic materials, composite materials (e.g., fiberglass composites, carbon fiber composites), and other materials, which may include inserts (e.g., threaded inserts, load-bearing inserts) to support various mounting techniques. A radome attachment structure 210 may include various structures that are configured for coupling a radome 145 with an exterior surface of a vehicle 130. For example, a radome attachment structure 210 may include an interface 215 for coupling (e.g., mounting, fastening, adhering, sealing) the radome attachment structure 210 to a vehicle 130, and an interface 216 for coupling a radome 145 to the radome attachment structure 210. In some cases, the radome attachment structure 210 may also include an interface for coupling an antenna system 140 with the radome attachment structure 210. For example, the radome attachment structure 210 may be connected to the fuselage via the interface 215, and an antenna system 140 may be connected with the radome attachment structure 210, such that the antenna system 140 is connected to the fuselage via the radome attachment structure 210. In some other examples, an antenna system 140 may be coupled with the aircraft within an opening 211 of the radome attachment structure 210 (e.g., as illustrated in the system 200-b of FIG. 2B), such that the antenna system 140 may be mounted directly to the aircraft. For example, the antenna system 140 may include an interface for coupling the antenna system 140 with the fuselage. In some examples, a top surface of a radome attachment structure 210 may be a flat surface that is aligned in an xy-plane, or has a flat or curved surface having a normal vector at least partially along the z-direction. In some other implementations, a radome attachment structure 210 may be omitted, and a radome 145 may be mounted directly to a vehicle 130. In some examples, a radome attachment structure 210 may be configured to be located below a field of view 175 of an antenna system 140. In some examples, a vehicle may include a fairing, which may be separate from a radome attachment structure 210.

A system 200 may also include one or more attenuation features 220 (e.g., RF signal attenuation features), which may be coupled with (e.g., mounted to, applied to, connected with) a radome attachment structure 210 or another mounting structure (e.g., separate from an antenna 141, separate from a radome attachment structure 210, such as a fairing) configured to locate attenuation features in accordance with the described techniques. For example, attenuation features 220 may be different than features of an antenna 141 (e.g., not integral to an antenna 141), such that attenuation features 220 may be mounted with the system 200 separately from one or more antennas 141. In other words, at least some attenuation features 220 may be mounted to (e.g., affixed to, separate from, applied to) a vehicle 130, which may include a mounting via an intervening mounting structure (e.g., a radome attachment structure 210, a fairing, or other mounting structure). Such mounting may include the use of threaded fasteners, rivets, pins, slots, adhesives, or any combination thereof, among other mounting techniques.

In various examples, one or more attenuation features 220 may be coupled with a top surface of a radome attachment structure 210, or one or more attenuation features 220 may be coupled with a side surface of a radome attachment structure 210, or combinations thereof. Attenuation features 220 may include various materials, components, or assemblies that are configured to attenuate electromagnetic transmission from an antenna system 140 from propagating along a direction relative to the antenna system 140-a. For example, one or more attenuation features 220 may be coupled with the radome attachment structure 210 or other mounting structure at or below a field of view 175 of an antenna system 140, and may be configured to attenuate electromagnetic transmissions of the antenna system 140 in an operating frequency band (e.g., one or more operating frequencies) of the antenna system 140.

In some examples, attenuation features 220 may at least partially attenuate electromagnetic transmissions of an antenna system 140 from propagating below an angle 221 (e.g., an angle associated with a field of view 175 of an antenna system 140), which may be measured from a surface of a radome attachment structure 210, or relative to an antenna system 140 (e.g., from a center of an antenna system 140, from a mounting surface of an antenna system 140, from one or more antennas 141, from one or more apertures 205, from a swept volume of an antenna system 140), or relative to a vehicle 130 on which a system 200 is mounted. An angle 221 may be representative of various angles associated with different configurations of the antenna system 140-a. Attenuation features 220 may impede electromagnetic transmissions in a region associated with the angle 221 based on the attenuation features 220 being implemented at the radome attachment structure 210. For example, attenuation features 220 may be mounted on a top surface of a radome attachment structure 210, which may be between a radome attachment structure 210 and a bottom of an antenna system 140. In some examples, an attenuation feature 220 may extend (e.g., from a radome attachment structure 210) with a height dimension at least partially along the z-direction from a surface of the radome attachment structure 210 (e.g., from a top surface, from a surface of a weight-relieving pocket of a radome attachment structure 210, or other location). Thus, in some examples, attenuation features 220 may be configured to attenuate electromagnetic transmissions of an antenna system 140 from propagating below a radome attachment structure 210.

In some cases, attenuation features 220 may be positioned below a swept volume of an antenna system 140 (e.g., below a swept volume of an antenna system 140-b associated with a mechanical steering system). In some cases, an antenna system 140 (e.g., antenna system 140-a) may be located with a distance 222 above the one or more attenuation features 220 (e.g., along the z-direction). Although, attenuation features 220 may be located (e.g., mounted) below a field of view 175 of an antenna system 140 (e.g., at least partially if not entirely below a field of view 175), in some examples, attenuation features 220 may additionally be at least partially or entirely located (e.g., mounted) at a boundary of a field of view 175, or at least partially into a field of view 175, among other examples.

In some examples, attenuation features 220 may be implemented differently along a fore-aft direction (e.g., along an x-direction, along a primary direction of travel) than along a side-to-side direction. For example, for a vehicle 130 having a body that is relatively elongated along the x-direction (e.g., a fuselage of a vehicle), regions 171 and 172 may be relatively larger (e.g., spanning relatively larger angles) in a yz-plane than in an xz-plane. Accordingly, to provide relatively higher attenuation (e.g., for relatively larger regions 171 and 172 in a yz-plane), in some implementations, attenuation features 220 may be symmetrically implemented (e.g., as pairs) across a centerline of a vehicle (e.g., in pairs symmetric across an xz-plane, as left-right pairs). In such examples, attenuation features 220 may be configured with various extents along the x-direction, which may be the same between different instances or types of attenuation features 220, or different between different instances or types of attenuation features 220. In some examples, such as for vehicles 130 in which sufficient attenuation is provided along the centerline (e.g., a centerline along the x-direction, a centerline in an xz-plane) of the vehicle 130 (e.g., fuselage attenuation, by way of a relatively large region 173 along an xz-plane), attenuation features 220 may not be implemented along a centerline of a vehicle (e.g., from an antenna system 140), or within a region (e.g., a region ahead of an antenna system 140 along the x-direction, a region behind an antenna system 140 along the x-direction, or both) having a threshold distance from a centerline (e.g., along the y-direction). In some other examples, attenuation features 220 may be implemented in a circular, elliptical, or polygonal arrangement (e.g., around a centerline of an antenna system 140, about an axis in the z-direction).

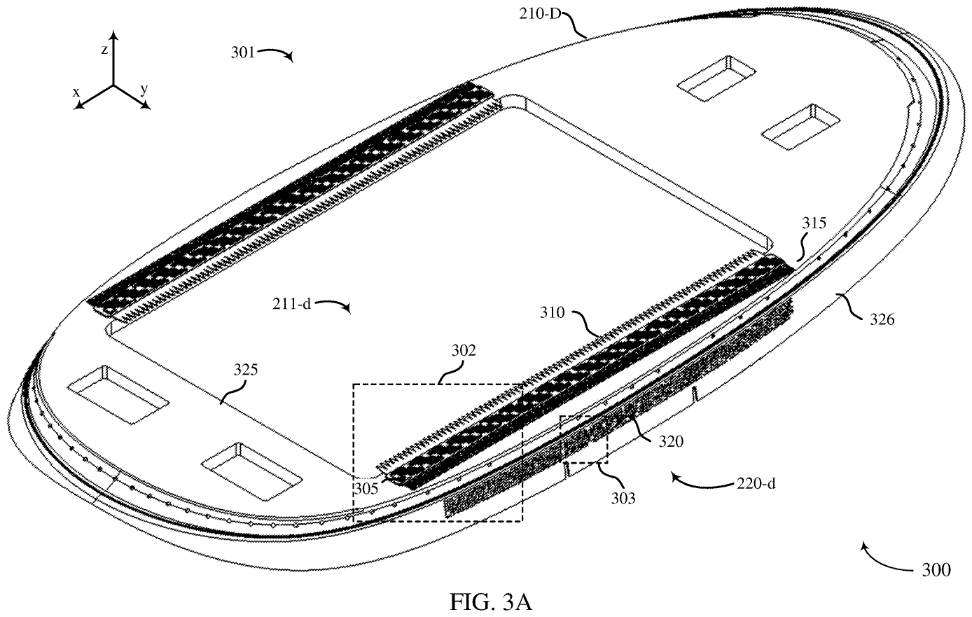

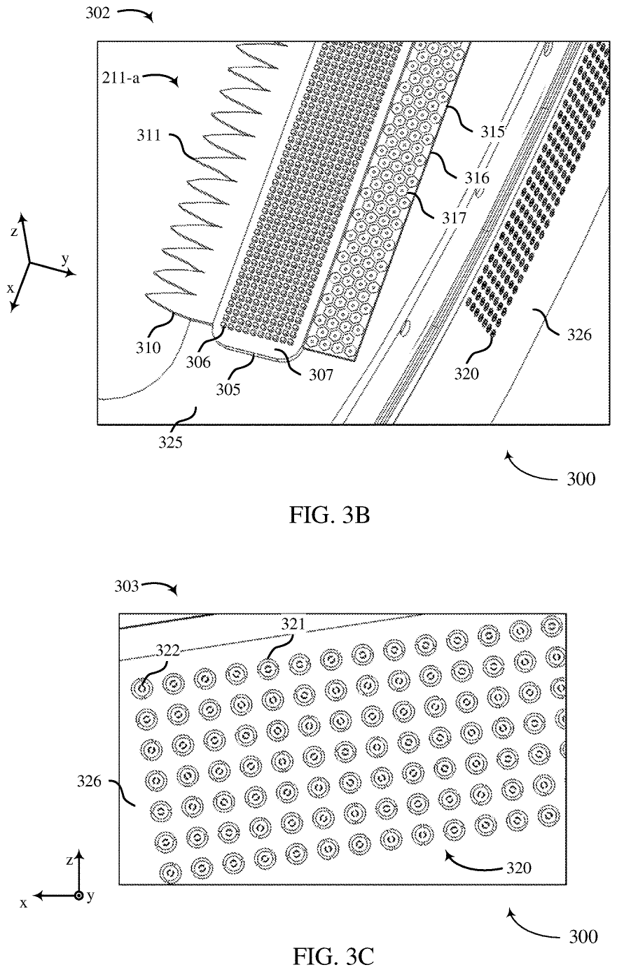

FIGS. 3A through 3C show an example of a system 300 that supports fuselage attenuation techniques in accordance with examples as described herein. The system 300 may be an example of aspects of a system 200 (e.g., an example for implementing aspects of an antenna signal attenuation apparatus), and include one or more attenuation features 220-d (e.g., mounted to a radome attachment structure 210-d) that are configured to attenuate electromagnetic transmissions of an antenna system 140 in an operating frequency band of the antenna system 140, including sidelobe transmissions or other transmissions along directions different than a boresight direction (e.g., different than directions in a field of view 175, different than directions of peak gain). The system 300 may be configured for mounting to a vehicle 130, such as an aircraft. Aspects of the system 300 may be described with reference to the illustrated coordinate system. FIGS. 3A through 3C illustrate the system 300 from various trimetric views. For example, FIG. 3A illustrates the system 300 from a macro view 301, FIG. 3B illustrates the system 300 from a detailed view 302, and FIG. 3C illustrates the system 300 from a micro view 303.

In some examples, attenuation features 220-d may be configured to attenuate electromagnetic transmissions along directions having a vector component in a downward direction (e.g., a negative z-direction, a direction below a field of view 175) of a vehicle coordinate system, including in a region relative to a vehicle 130 on which the radome attachment structure 210-d or other mounting structure is mounted. In some examples, attenuation features 220-d may attenuate electromagnetic transmissions from propagating below an angle relative to the vehicle 130. In some cases, attenuation features 220-d may be configured to attenuate electromagnetic transmissions (e.g., sidelobes) between one or more apertures 205 of the antenna system 140 and an exterior surface (e.g., a surface 131) of the vehicle 130. In some examples, attenuation features 220-d may be configured for location between (e.g., along the z-direction) a swept volume of one or more antennas 141 (e.g., apertures 205) and the exterior surface of the vehicle 130. In some examples, attenuating the electromagnetic transmissions may include disrupting a coherence of the electromagnetic transmissions along a direction associated with the height dimension (e.g., along the z-direction). In some implementations, attenuating the electromagnetic transmissions may include changing a propagation direction of the electromagnetic transmissions. For example, attenuation features 220-d may redirect, reflect, absorb, or reemit the electromagnetic transmissions.

Some examples of attenuation features 220 may implement one or more metamaterials (e.g., meta materials, meta-materials, including a class of materials that may be referred to as “metamaterial absorbers”), which may refer to materials that are engineered (e.g., by feature shape, by feature dimension, by feature spacing, by feature orientation, by feature pattern, by feature location) to have one or more properties that do not normally occur in naturally-occurring configurations of the materials. For example, metamaterials implemented in attenuation features 220 may include conductive materials (e.g., copper, silver, gold, aluminum, stainless steel, or any combination thereof) that are configured to interact with electromagnetic transmissions of an antenna system 140 (e.g., as a frequency-selective surface, as a frequency-selective volume), such that the metamaterials attenuate the electromagnetic transmissions (e.g., at one or more frequencies of an operating frequency band of an antenna system 140). Metamaterials for attenuation features 220 may implemented in various locations, such as being mounted to a radome attachment structure 210, a fairing (e.g., separate from a radome attachment structure), or other mounting structure that may be mounted to a vehicle 130.

In some examples, metamaterials (e.g., resonant metamaterials) may include a plurality of conductor portions that are configured for resonance at one or more wavelengths and, when implemented in attenuation features 220, such resonant wavelengths may correspond to an operating frequency band (e.g., one or more operating frequencies) of an antenna system 140. For example, resonant metamaterials may include features configured in two dimensions or three dimensions, for implementing material features (e.g., conductor portions) along various directions. In some examples, an attenuation feature 220 may include an implementation of one or more materials with feature dimensions, feature shapes, feature spacing, or a combination thereof that are associated with one or more frequencies of an operating frequency band of an antenna system 140 (e.g., for establishing resonant properties that are associated with a size, a shape, or a pattern of conductor portions). For example, feature dimensions, feature shapes, feature spacing, or a combination thereof may have one or more dimensions that are related to a wavelength of electromagnetic transmissions, such as having dimensions that are less than a wavelength of electromagnetic transmissions (e.g., less than one or more wavelengths associated with an operating frequency band of an antenna system 140), equal to or near (e.g., within one percent, within five percent, within ten percent, within twenty-five percent) a half-wavelength of the electromagnetic transmissions, or a range of such dimensions (e.g., in accordance with a pattern, in accordance with a random arrangement) associated with a range of wavelengths (e.g., of a range of frequencies) corresponding to an operating frequency band of an antenna system 140.

Some examples of metamaterials that may be implemented in attenuation features 220 may not be associated with a resonant phenomenon (e.g., may be different than resonant metamaterials). For example, non-resonant metamaterials may include or be referred to as an artificial magnetic conductor (AMC), which may be configured to mitigate surface wave propagation. In some examples, AMCs may be configured to attenuate surface wave propagation, which may be a primary mechanism for unwanted emissions in a deep shadow region (e.g., a region 173).

In some examples of a system 300, attenuation features 220-d may include one or more conductive structures 305, one or more serrated structures 310, one or more composite conductor structures 315, or a plurality of split rings 320 (e.g., split conductive rings), or a combination thereof, among other attenuation features 220-d. Additionally, or alternatively, attenuation features 220-d may include a conductive coating applied to the radome attachment structure 210-d, or a material (e.g., a form material, a bulk material coupled with an exterior surface of the radome attachment structure 210-d that is configured to absorb at least a portion of the electromagnetic transmissions, or a combination thereof. Attenuation features 220-d may be mounted to one or more surfaces of the radome attachment structure 210-d or other mounting structure. For example, conductive structures 305, serrated structures 310, or composite conductor structures 315, or a combination thereof may be mounted to a top surface 325 of the radome attachment structure 210-d. In some cases, conductive structures 305 may be adjacent to serrated structures 310 (e.g., along the y-direction), and composite conductor structures 315 may be adjacent to conductive structures 305 (e.g., along the y-direction), among other implementations. Additionally, or alternatively, split rings 320 may be coupled with (e.g., mounted to, inlaid in) a side surface 326 of the radome attachment structure 210-d.

Composite conductor structures 315 may include conductor portions 317 arranged on dielectric portion 316, and may be an example of a metamaterial (e.g., a resonant metamaterial) configured to mitigate surface wave propagation. For example, composite conductor structures 315 may each include a dielectric portion 316 extending along (e.g., across) the top surface 325 of the radome attachment structure 210-d, and a quantity of conductor portions 317 arranged in a pattern on the dielectric portion 316. Conductor portions 317 may be arranged in a grid-like pattern, or a staggered pattern, among other patterns, and may be configured for resonance at one or more wavelengths corresponding to an operating frequency band of an antenna system 140. In some examples, conductor portions 317 may formed in accordance with printed circuit board (PCB) techniques, such as preferentially removing portions of a layer of conductive material (e.g., copper) that is formed on a layer of dielectric material (e.g., fiberglass). In some examples, conductor portions 317 may have a same size, or subsets of the conductor portions 317 may have different sizes. In some examples, the conductor portions 317 may be shaped such that each conductor portion 317 forms a rectangular shape or a hexagonal shape, among other shapes configured to attenuate electromagnetic transmissions. Conductor portions 317 may have one or more sizes, one or more shapes, one or more spacings, or combinations thereof that are based on an operating frequency band (e.g., one or more operating frequencies) of an antenna system 140, such that the dimensions of or pattern of the conductor portions 317 may be associated with attenuating electromagnetic transmissions at one or more frequencies of the operating frequency band. The materials formed into conductor portions 317 may thus be configured to interact with electromagnetic transmissions to attenuate the electromagnetic transmissions (e.g., at one or more frequencies of an operating frequency band of an antenna system 140). Although illustrated as being coupled with the radome attachment structure 210-d, composite conductor structures 315 may additionally, or alternatively, be mounted directly to a fuselage of a vehicle 130.

Split rings 320 may be another example of a metamaterial (e.g., a resonant metamaterial), where split rings 320 may also be an example of conductor portions configured for resonance at one or more wavelengths corresponding to an operating frequency band of an antenna system 140. Split rings 320 may include conductive material along a surface (e.g., a side surface 326) of the radome attachment structure 210-d, such as a conductive material that may be inlaid into the surface of the radome attachment structure 210-d. In some examples, split rings 320 may be molded into, injected into, or deposited onto (e.g., sprayed, in accordance with a masking pattern) the side surface 326 of the radome attachment structure 210-d. Additionally, or alternatively, split rings 320 may be mounted to the side surface 326 of the radome attachment structure 210-d. Each split ring 320 may include a conductive material extending normal to the side surface 326 of the radome attachment structure 210-d. In some examples, one or more of (e.g., each of) such split ring 320 may include an outer ring 321 and an inner ring 322 of the conductive material, and orientations of splits among the split rings 320 may be aligned along the same direction or different directions (e.g., random angles, to disrupt a coherence of electromagnetic transmissions, to depolarize electromagnetic transmissions). In some examples, the split rings 320 may be arranged in a grid-like pattern along the side surface 326. In some implementations, the conductive material may be a PCB material (e.g., of a conductor layer). In some implementations, the conductive material may be an example of a metamaterial configured to interact with electromagnetic transmissions, such that the split rings 320 are designed to attenuate electromagnetic transmissions (e.g., at a frequency). In some examples, split rings 320 may be configured to depolarize electromagnetic transmissions. In some such examples, the split rings 320 may depolarize electromagnetic transmissions extending below an angle relative to the top surface 325 of the radome attachment structure 210-d by reducing radiation associated with the electromagnetic transmissions. In some other examples, such techniques may additionally, or alternatively, be implemented with pin structures that may be injection molded into a radome attachment structure 210 or machined into an applique or adapter coupled with a radome attachment structure 210. Although the split rings 320 illustrated in the system 300 include circular rings that are split, split rings may include other shapes, such as ellipses, polygons and other regular or irregular shapes, including various conductive shapes that are resonant or near-resonant at the one or more frequencies of an operating frequency band of an antenna system 140. Further, although split rings 320 are illustrated as an implementation on a side surface 326, split rings 320 may additionally, or alternatively, be implemented on another surface of a radome attachment structure 210, such as a surface 325 or other surface. In some examples, split rings 320 may additionally, or alternatively, be implemented on a fairing or other structure for installation on a vehicle 130, which may be separate from a radome attachment structure 210, separate from a radome 145, or separate from both.

Conductive structures 305 may include an arrangement of multiple conductive pillars 306, and may be an example of a metamaterial (e.g., a non-resonant metamaterial), such as an AMC, that is configured to mitigate surface wave propagation. Conductive structures 305 may each include a quantity of conductive pillars 306 arranged in a pattern (e.g., in an xy-plane) on the top surface 325 of the radome attachment structure 210-d. In some cases, conductive pillars 306 may be arranged in a grid-like pattern, and attenuation characteristics of the conductive pillars 306 may be based on dimensions, shapes, or patterns (e.g., the spacing of the pattern), which may be based on the operating frequency band (e.g., one or more operating frequencies) of an antenna system 140. Accordingly, the dimensions of or pattern of the conductive pillars 306 may be associated with attenuating electromagnetic transmissions at one or more frequencies of the operating frequency band. Conductive pillars 306 may extend some distance along the z-direction (e.g., along a height dimension) from the top surface 325 of the radome attachment structure 210-d. Conductive pillars 306 may be prismatic or pyramidal structures extending up (e.g., along the z-direction) from the top surface 325. For example, the conductive pillars 306 may have a rectangular cross-section in an xy-plane, which may be straight along the z-direction or may taper along the z-direction. In some cases, the conductive pillars 306 may be formed on a conductive base structure 307, such that the conductive pillars 306 may be arranged in the pattern on the conductive base structure 307 and extend from the conductive base structure 307. In some implementations, conductive structures 305 may be formed using sheet metal diffraction grating patterns. In other implementations, the conductive structures 305 may be formed using machined or cast corrugation patterns. Although illustrated as being coupled with the radome attachment structure 210-d, conductive structures 305 may additionally, or alternatively, be mounted directly to a fuselage of a vehicle 130.

Serrated structures 310 may include an arrangement of multiple conductive serrations 311. For example, serrated structures 310 may each include a quantity of conductive serrations 311 arranged in a pattern on the top surface 325 of the radome attachment structure 210-d. In some cases, conductive serrations 311 may be arranged in one or more rows extending into an opening 211-a of the radome attachment structure 210-d. In some such cases, conductive serrations 311 may be spaced along one or more rows, such that each conductive serration 311 may be a distance (e.g., along the x-direction) away from an adjacent conductive serration 311. In some examples, one or more conductive serrations 311 may extend coplanar (e.g., along the y-direction, in an xy-plane) with the top surface 325 of the radome attachment structure 210-d into the opening 211-a. In some other examples, conductive serrations 311 may extend at an angle (e.g., about the x-direction, along a direction in a yz-plane) relative to the top surface 325 of the radome attachment structure 210-d into the opening 211-a. In some implementations, a subset of conductive serrations 311 may extend at an angle relative to the top surface 325, and another subset of conductive serrations 311 may extend at another angle relative to the top surface 325.

Conductive serrations 311 may have an angle, size, shape, or spacing, or combination thereof that is based on an operating frequency band of an antenna system 140, such that the dimensions of or pattern of the conductive serrations 311 may be associated with attenuating electromagnetic transmissions at one or more frequencies of the operating frequency band. For example, the angle, size, shape, or spacing of the conductive serrations 311, or subsets of the conductive serrations 311, may be configured to disrupt the electromagnetic transmissions (e.g., sidelobe emissions) in a region relative to the system 300. In some implementations, serrations 311 may have one or more dimensions that extend beyond a wavelength of electromagnetic transmissions to be attenuated, and may operate in accordance with geometric optics or a diffraction device. In some examples, conductive serrations 311 may have a same size (e.g., a same length, along the y-direction), or subsets of conductive serrations 311 may have different sizes (e.g., different sizes associated with a range of wavelengths corresponding to an operating frequency band of an antenna system 140, which may include a sequence of different sizes or a distributed or random arrangement of different sizes). In some examples, conductive serrations 311 may be shaped such that each conductive serration 311 forms a triangular structure (e.g., in an xy-plane). Conductive serrations 311 may be made from conductive materials including copper, aluminum, stainless steel, or any combination thereof. The materials formed into conductive serrations 311 may thus be configured to interact with electromagnetic transmissions to attenuate the electromagnetic transmissions (e.g., at one or more frequencies of an operating frequency band of an antenna system 140).

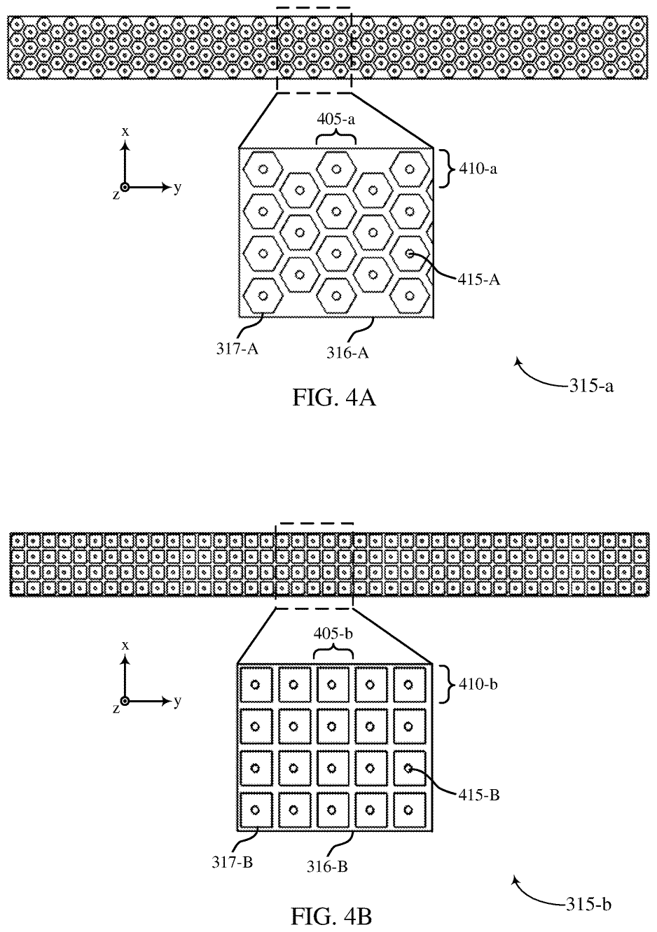

FIGS. 4A and 4B show examples of composite conductor structures 315-a and that support fuselage attenuation techniques in accordance with examples as described herein. The composite conductor structure 315-a and the composite conductor structure 315-b may be implemented in a system 200 or a system 300 (e.g., as aspects of an antenna signal attenuation apparatus). For example, the composite conductor structures 315-a and 315-b may be connected to a radome attachment structure 210 or other mounting structure. Aspects of the composite conductor structures 315-a and 315-b may be described with reference to the illustrated coordinate system. FIGS. 4A and 4B illustrate the composite conductor structure 315-a and the composite conductor structure 315-b from a wholistic top view and a detailed top view expanded from the wholistic top view. The composite conductor structures 315-a and 315-b may be configured to attenuate electromagnetic transmissions of an antenna system 140 at one or more frequencies of an operating frequency band of the antenna system 140.

The composite conductor structures 315-a and 315-b may include dielectric portions 316-a and 316-b, respectively, and conductor portions 317-a and 317-b, respectively, and the dielectric portions 316 may form a base structure for the conductor portions 317. The composite conductor structures 315 may include a metamaterial (e.g., a resonant metamaterial), which may be implemented in accordance with one or more PCB techniques (e.g., as a PCB metamaterial). In various examples, such materials may include standard or impedance-controlled substrates (e.g., as a dielectric portion 316). In some examples, composite conductor structures 315-a and 315-b may include vias 415-a and 415-b, respectively, which may provide conductive paths from surface structures to a ground layer (e.g., a copper ground plane), which may be clamped to a ground source of a radome attachment structure 210 to provide an RF ground.

FIG. 4A illustrates a composite conductor structure 315-a, in which conductor portions 317-a are arranged in a staggered pattern. For example, conductor portions 317-a may be arranged in columns 405-a, where each column 405-a is staggered relative to the x-direction. That is, conductor portions 317-a in a column 405-a may be staggered from conductor portions 317-a in an adjacent column 405-b along the x-direction. Likewise, conductor portions 317-a may be arranged in rows 410-a, where conductor portions 317-a of a row 410-a are staggered within the row 410-a relative to the x-direction. FIG. 4A illustrates the conductor portions 317-a as hexagonal shapes, but similar techniques may be implemented with other shapes (round, circular, elliptical, polygonal, triangular, octagonal).

FIG. 4B illustrates a composite conductor structure 315-b, in which conductor portions 317-b are arranged in a grid pattern. For example, conductor portions 317-b may be arranged in columns 405-b, where conductor portions 317-b of a column 405-b are aligned within the column 405-b relative to the y-direction. Likewise, conductor portions 317-b may be arranged in rows 410-b, where conductor portions 317-b of a row 410-b are aligned within the row 410-b relative to the x-direction.

FIG. 4B illustrates the conductor portions 317-b as rectangular (e.g., square) shapes, but similar techniques may be implemented with other shapes (round, circular, elliptical, polygonal, triangular, octagonal).

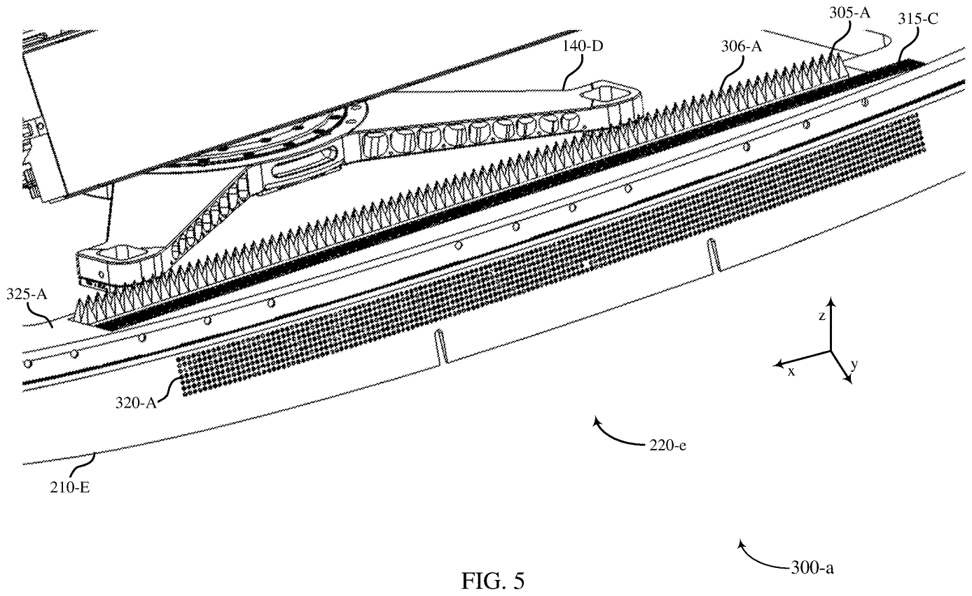

FIG. 5 shows an example of a system 300-a that supports fuselage attenuation techniques in accordance with examples as described herein. The system 300-a may be an example of aspects of a system 200 (e.g., an example for implementing aspects of an antenna signal attenuation apparatus), and include one or more attenuation features 220-e (e.g., mounted to a radome attachment structure 210-e) that are configured to attenuate electromagnetic transmissions of an antenna system 140-d at one or more frequencies of an operating frequency band of the antenna system 140-d, including sidelobe transmissions or other transmissions along directions different than a boresight direction (e.g., different than directions in a field of view 175, different than directions of peak gain). The system 300-a may be configured for mounting to a vehicle 130, such as an aircraft. Aspects of the system 300-a may be described with reference to the illustrated coordinate system. For example, FIG. 5 illustrates the system 300-a from a trimetric view.

In the example of system 300-a, the attenuation features 220-e may include conductive structures 305-a, composite conductor structures 315-c, and split rings 320-a (e.g., implemented symmetrically across an xz-plane). The conductive structures 305-a may extend along a top surface 325-a of the radome attachment structure 210-e, and may include a quantity of conductive pillars 306-a. The conductive pillars 306-a may be arranged in a grid-like pattern, such that the conductive structures 305-a may include one or more rows of the conductive pillars 306-a. The conductive pillars 306-a may be pyramidal structures extending along a direction perpendicular to the top surface 325-a of the radome attachment structure 210-e. In some cases, the conductive pillars 306-a may extend up from the top surface 325-a of the radome attachment structure 210-e. However, in some cases, the conductive pillars 306-a may extend from below the top surface 325-a of the radome attachment structure 210-e. For example, conductive pillars 306-a may be inset within the top surface 325-a of the radome attachment structure 210-e. In some examples, the radome attachment structure 210-e may include pockets, which may be associated with conserving weight of the radome attachment structure 210-e, and conductive pillars 306-a may be inserted or formed within the pockets. In some implementations, conductive pillars 306-a may be made from metamaterials or bulk materials (e.g., foam materials) associated with attenuating the electromagnetic transmissions. In some such implementations, the conductive pillars 306-a may at least partially absorb the electromagnetic transmissions.

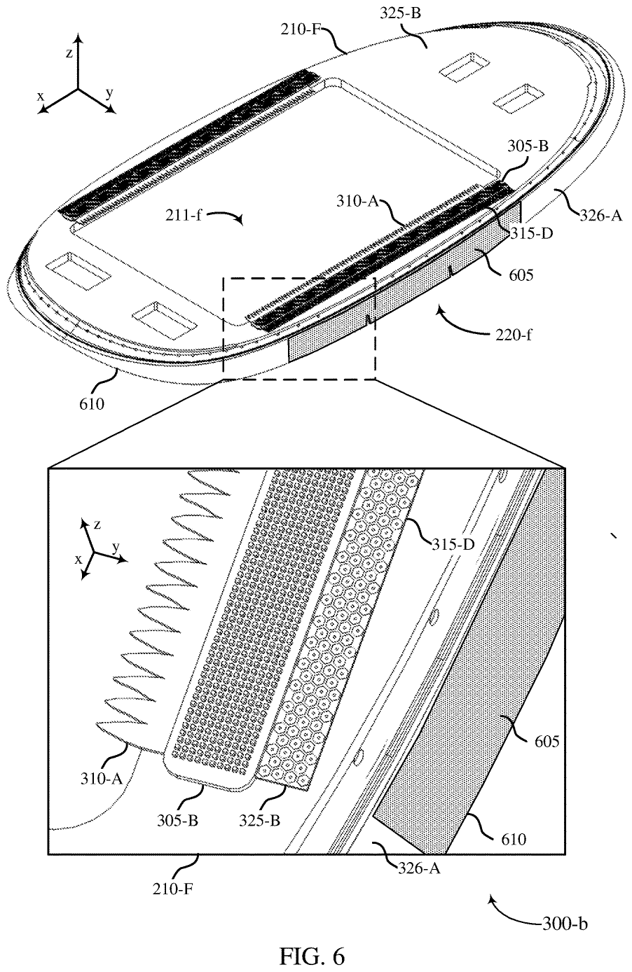

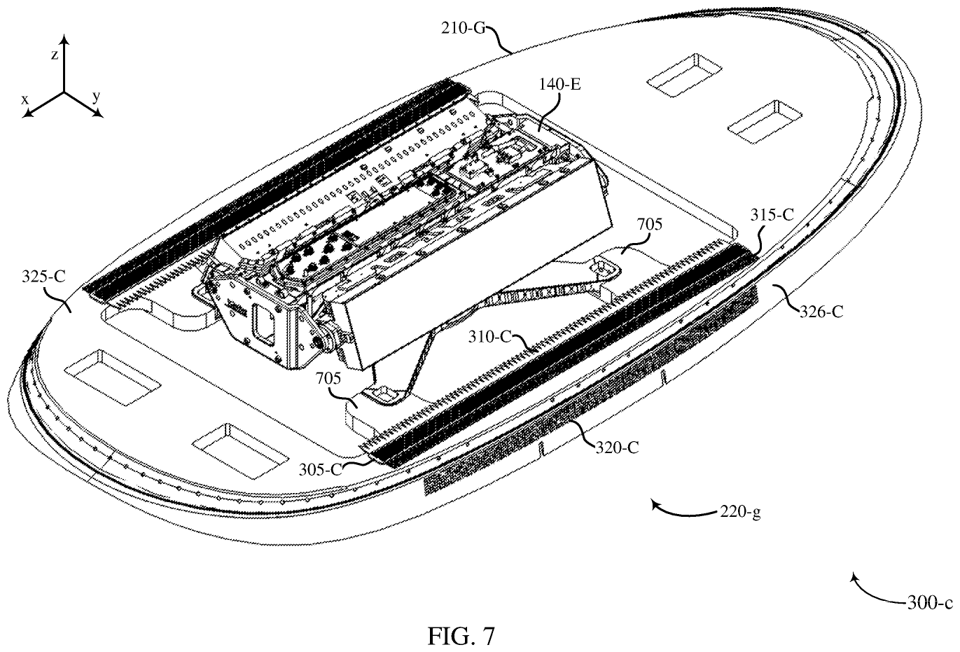

FIG. 6 shows an example of a system 300-b that supports fuselage attenuation techniques in accordance with examples as described herein. The system 300-b may be an example of aspects of a system 200 (e.g., an example for implementing aspects of an antenna signal attenuation apparatus), and include one or more attenuation features 220-f (e.g., mounted to a radome attachment structure 210-f) that are configured to attenuate electromagnetic transmissions of an antenna system 140 at one or more frequencies of an operating frequency band of the antenna system 140-d, including sidelobe transmissions or other transmissions along directions different than a boresight direction (e.g., different than directions in a field of view 175, different than directions of peak gain). The system 300-b may be configured for mounting to a vehicle 130, such as an aircraft. Aspects of the system 300-b may be described with reference to the illustrated coordinate system. For example, FIG. 6 illustrates the system 300-b from a wholistic trimetric view and a detailed trimetric view expanded from the wholistic trimetric view.

In the example of system 300-b, the attenuation features 220-f may include conductive structures 305-b, composite conductor structures 315-d, and a conductive coating 605. A conductive coating 605 may extend along a side surface 326-a of the radome attachment structure 210-f. For example, a conductive coating 605 may extend for a distance along the x-direction, and may extend (e.g., along the z-direction) from a bottom surface 610 of the radome attachment structure 210-c to a top surface 325-b of the radome attachment structure 210-c, or some portion thereof. In some cases, a conductive coating 605 may be applied to the side surface 326-a of the radome attachment structure 210-c. For example, a conductive coating 605 may be sprayed along the side surface 326 by an applicator. In some other examples, a conductive coating 605 may be inlaid within the side surface 326 during manufacturing of the radome attachment structure 210-f. A conductive coating 605 may include conductive materials or metamaterials associated with attenuating electromagnetic transmissions. In some such implementations, the conductive coating 605 may at least partially absorb (e.g., block) electromagnetic transmissions. In some examples, a conductive coating 605 may be a paint including an infusion of conductive materials or metamaterials. For example, a conductive coating 605 may be a copper paint (e.g., an adhesive paint infused with copper). In some cases, a protective coating may be applied over a conductive coating 605.

In some cases, a system 300 such as the system 300-b may include materials (e.g., material structures, bulk materials, foam materials, not illustrated) associated with absorbing the electromagnetic transmissions. Such materials may differ from metamaterials, for example, by supporting attenuation techniques as a function of a bulk property of the material (e.g., separate from attenuation dependent on shape or patterns). Such materials may include homogenous materials, or mixtures, such as iron-loaded epoxy and other composites. In some examples, such materials may be attached to the radome attachment structure 210-f, or implemented within the radome attachment structure 210-f. That is, the material may be implemented beside or within sidewalls of the radome attachment structure 210-f to act as an electromagnetic absorption feature.

In some examples, such materials may be implemented within an opening 211-f of the radome attachment structure 210-f. In some examples, such materials may be implemented against a radome 145 (e.g., not illustrated) attached to the radome attachment structure 210-f.

FIG. 7 shows an example of a system 300-c that supports fuselage attenuation techniques in accordance with examples as described herein. The system 300-c may be an example of aspects of a system 200 (e.g., an example for implementing aspects of an antenna signal attenuation apparatus), and include one or more attenuation features 220-g (e.g., mounted to a radome attachment structure 210-g, implemented symmetrically across an xz-plane) that are configured to attenuate electromagnetic transmissions of an antenna system 140-e at one or more frequencies of an operating frequency band of the antenna system 140-e, including sidelobe transmissions or other transmissions along directions different than a boresight direction (e.g., different than directions in a field of view 175, different than directions of peak gain). The system 300-c may be configured for mounting to a vehicle 130, such as an aircraft. Aspects of the system 300-c may be described with reference to the illustrated coordinate system.

In the example of system 300-c, the attenuation features 220-g may include conductive structures 305-c, serrated conductors 310-c, and composite conductor structures 315-c (e.g., on a surface 325-c), and split rings 320-c (e.g., on a surface 326-c), and the attenuation features 220-g may be implemented symmetrically across an xz-plane. In the example of system 300-c, the radome attachment structure 210-g may include an interface 705 for coupling with the antenna system 140-e (e.g., with a mechanical steering system of the antenna system 140-e. The radome attachment structure 210-g may include the interface 705 for mounting the antenna system 140-e to a vehicle 130. In various examples, an interface 705 may include any quantity of one or more mounting locations (e.g., mounting pads, attachment points), which may support various mounting techniques such as fastener mounting, slotted mounting, pinned mounting, welded mounting, and other techniques or combinations thereof.

Thus, in accordance these and other examples, a system (e.g., a system 200, a system 300, an antenna signal attenuation apparatus, signal attenuation features 220) may be implemented on a vehicle 130 to mitigate signal propagation that may interfere with other devices or other communication systems. The system may include a mounting structure, such as a radome attachment structure 210 or other structure, configured for coupling with a surface of a vehicle 130 via an interface 215. The system may include one or more attenuation features 220 (e.g., metamaterials, AMCs, and other features) that are configured to attenuate electromagnetic transmissions of an antenna system 140 (e.g., at one or more frequencies of an operating frequency band of the antenna system 140, at or below a field of view of the antenna system 140). For example, the attenuation features 220 may impede, absorb, redirect (e.g., reflect, absorb and reemit), or modify (e.g., disrupt a coherence, depolarize) electromagnetic transmissions propagating outside a field of view of the antenna system 140 relative to the vehicle 130, thereby reducing interference caused by the electromagnetic transmissions outside the field of view. In some examples, the attenuation features 220 may be configured to limit electromagnetic transmissions propagating below an angle relative to the vehicle 130 (e.g., below a field of view 175), which may prevent the electromagnetic transmissions from interfering with wireless signaling communicated by other devices (e.g., ground-based devices) that may be using the similar wireless spectrum.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The detailed description set forth above in connection with the appended drawings describes examples and does not represent the only examples that may be implemented or that are within the scope of the claims. The term “example,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An antenna signal attenuation apparatus, comprising:
a radome attachment structure configured for coupling a radome with an exterior surface of a vehicle, the radome associated with a volume for arrangement of an antenna system having a boresight configurable within a field of view of the antenna system relative to the vehicle and an operating frequency band, and the radome attachment structure configured with an opening through which the antenna system can be mounted to the vehicle; and
one or more signal attenuation features mounted to the radome attachment structure and below the field of view of the antenna system, the one or more signal attenuation features configured to attenuate electromagnetic transmissions of the antenna system between the antenna system and the exterior surface of the vehicle and in the operating frequency band.

2. The antenna signal attenuation apparatus of claim 1, further comprising the antenna system, the antenna system having a steering system configured to steer the boresight within the field of view.

3. The antenna signal attenuation apparatus of claim 1, wherein the one or more signal attenuation features are configured for location between a swept volume of one or more antennas of the antenna system and an interface for coupling the radome attachment structure with the exterior surface of the vehicle.

4. The antenna signal attenuation apparatus of claim 1, wherein two or more of the signal attenuation features are configured for symmetric implementation across a centerline of the vehicle.

5. The antenna signal attenuation apparatus of claim 1, wherein the one or more signal attenuation features are not configured for location along a centerline of the vehicle.

6. The antenna signal attenuation apparatus of claim 1, wherein the one or more signal attenuation features are configured to disrupt a coherence of the electromagnetic transmissions between the antenna system and the exterior surface of the vehicle.

7. The antenna signal attenuation apparatus of claim 1, wherein the one or more signal attenuation features are configured to change a propagation direction of the electromagnetic transmissions between the antenna system and the exterior surface of the vehicle.

8. The antenna signal attenuation apparatus of claim 1, wherein the one or more signal attenuation features comprise:
one or more metamaterials configured to interact with the electromagnetic transmissions between the antenna system and the exterior surface of the vehicle.

9. The antenna signal attenuation apparatus of claim 8, wherein the one or more metamaterials comprise a plurality of conductor portions configured for resonance at one or more wavelengths corresponding to the operating frequency band.

10. The antenna signal attenuation apparatus of claim 9, wherein the resonance is associated with a size, a shape, or a pattern of the plurality of conductor portions that is based at least in part on the one or more wavelengths.

11. The antenna signal attenuation apparatus of claim 10, wherein the one or more signal attenuation features comprise:
one or more composite conductor structures each comprising a respective dielectric portion and a respective set of multiple conductor portions of the plurality of conductor portions coupled with the respective dielectric portion.

12. The antenna signal attenuation apparatus of claim 10, wherein the plurality of conductor portions comprise:
a plurality of split conductive rings applied to a side surface of the radome attachment structure.

13. The antenna signal attenuation apparatus of claim 12, wherein the plurality of split conductive rings are configured to depolarize the electromagnetic transmissions between the antenna system and the exterior surface of the vehicle.

14. The antenna signal attenuation apparatus of claim 8, wherein the one or more metamaterials comprise:
one or more conductive structures coupled with a top surface of the radome attachment structure and each comprising a respective plurality of conductive pillars extending above the top surface of the radome attachment structure.

15. The antenna signal attenuation apparatus of claim 14, wherein the respective plurality of conductive pillars are arranged in a grid pattern that is based at least in part on the operating frequency band.

16. The antenna signal attenuation apparatus of claim 14, wherein each of the respective plurality of conductive pillars comprises a respective rectangular cross-section extending along a direction normal to the top surface of the radome attachment structure.

17. The antenna signal attenuation apparatus of claim 14, wherein each of the respective plurality of conductive pillars comprises a pyramidal structure extending along a direction normal to the top surface of the radome attachment structure.

18. The antenna signal attenuation apparatus of claim 1, wherein the one or more signal attenuation features comprise:
one or more serrated structures connected to a top surface of the radome attachment structure and each comprising a respective plurality of conductive serrations

19. The antenna signal attenuation apparatus of claim 18, wherein the respective plurality of conductive serrations extend coplanar with the top surface of the radome attachment structure.

20. The antenna signal attenuation apparatus of claim 18, wherein the respective plurality of conductive serrations extend at one or more angles relative to the top surface of the radome attachment structure.

21. The antenna signal attenuation apparatus of claim 18, wherein the respective plurality of conductive serrations comprise a first subset of conductive serrations extending at a first angle relative to the top surface of the radome attachment structure and a second subset of conductive serrations extending at a second angle relative to the top surface of the radome attachment structure that is different than the first angle.

22. The antenna signal attenuation apparatus of claim 18, wherein the respective plurality of conductive serrations have one or more sizes, one or more shapes, or one or more spacings, or a combination thereof that are based at least in part on the operating frequency band.

23. The antenna signal attenuation apparatus of claim 1, wherein the one or more signal attenuation features comprise:
a conductive coating applied to a side surface of the radome attachment structure.

24. The antenna signal attenuation apparatus of claim 1, wherein the one or more signal attenuation features comprise:
a material coupled with the exterior surface of the radome attachment structure and configured to absorb at least a portion of the electromagnetic transmissions between the antenna system and the exterior surface of the vehicle.

25. The antenna signal attenuation apparatus of claim 1, wherein the one or more signal attenuation features are configured to attenuate the electromagnetic transmissions between the antenna system and the exterior surface of the vehicle from propagating below the radome attachment structure.

26. The antenna signal attenuation apparatus of claim 1, wherein the radome attachment structure is configured to be below the field of view of the antenna system.

27. The antenna signal attenuation apparatus of claim 1, further comprising:
the antenna system; and
the radome.
